(19) United States
(12) Patent Application Publication
(10) Pub. No.: US 2006/0135100 A1
(43) Pub. Date: Jun. 22, 2006

(54) Mobile phone capable of presenting a clock in a power-off mode

(75) Inventors: Jun Fang, Taipei (TW); David Ho, Taipei (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Inventec Appliances Corporation, Taipei (TW)

(21) Appl. No.: 11/188,150

(22) Filed: Jul. 22, 2005

(30) Foreign Application Priority Data
Dec. 9, 2004 (TW) 093138163

(51) Int. Cl. H04B 1/18

(52) U.S. Cl. 455/181.1

(57) ABSTRACT

A mobile phone capable of presenting a clock thereon in a power-off mode is disclosed, in which a user thereof may initialize the clock to be presented when the mobile phone is powered off simply by pressing a specific key on the mobile phone without the need of powering on the mobile phone. Further, when the mobile phone has dual display screens, a secondary display screen is used for presenting the clock so as to achieve the purposes of power saving and inconvenience elimination of outer body rotation of the mobile phone.

### BACKGROUND OF THE INVENTION

1. Field of the Invention

The present invention relates to a mobile phone and particularly a mobile phone capable of presenting a clock thereon in a power-off mode.

2. Descriptions of the Related Art

With the continued improvement in the communications technology, mobile phones have been equipped with more and more diverse functions, ranging from the traditional wireless communications in early days to multi-medium recreation, wireless net surfing and personal message management today. As generally considered, the mobile phone stands a good chance to become a platform integrated with functions provided by various of the current portable devices, such as personal digital assistants (PDAs) and EZ drives.

As more and more diverse functions are provided by the mobile phone, a user thereof is generally imposed with difficulty in use of the mobile phone, particularly for those users less familiar with or having a less inclination for electronic devices. Facing the dazzling array of function items in the mobile phone may sometimes frighten some users.

In another sense, only some simple functions may satisfy some users of the mobile phone. However, the execution of the simple functions may often require a complex procedure under the environment with the diverse functions presented in the mobile phone.

For example, a clock is a simple but practical function in a mobile phone. Particularly, since the today mobile phone provides an alarm clock, the mobile phone has been used as a timepiece in replace of the watch and alarm clock. As alluded above, setting, initialization and closing the alarm clock alone may require accessing several information folders since the functions are provided among the numerous diverse functions, which seems not efficient in the practical use.

Further, many users are in the habit of turning off the mobile phone before they go to bed for the sake of an undisturbed nighttime. At this time, if the user desires to know the time from the mobile phone or modify the settings of the alarm clock, he or she has to power on the mobile phone and then has these operations conducted in the nighttime, which seems troublesome and power consuming.

Therefore, there is a need to provide a mobile phone capable of presenting a clock thereon in a power-off mode so that the above mentioned inconveniences may be avoided and competitiveness thereof may be boosted.

### SUMMARY OF THE INVENTION

It is, therefore, an object of the present invention to provide a mobile phone capable of presenting a clock thereon in a power-off mode through which a user thereof may initialize the clock rapidly when it is in the power-off state.

To achieve the above object, a mobile phone capable of presenting a clock thereon in a power-off mode according to the present invention comprises a flash memory, a random access memory (RAM), a real time clock, a quick key module and a secondary display screen. When the mobile phone is powered off and the user desires to have the clock presented therein, he or she may initialize the clock simply by pressing a quick key in the quick key module. At this time, a keyboard drive program, a display drive program and a clock drive program stored in the flash memory are loaded into the RAM to drive the quick key module, secondary display screen and real time clock, respectively. Correspondingly, the secondary display screen is initialized and displays the time provided by the real time clock. The user may also execute other clock functions by pressing a corresponding quick key in the quick key module.

When the mobile phone does not receive a new instruction within a specific period, the clock drive program serves as an interrupt service program to close the secondary display screen and restores the mobile phone back to the power-off state.

Other objects, structural features and functions may be further understood after the description below is read with reference to the accompanying drawings.

### BRIEF DESCRIPTION OF THE DRAWINGS

FIG. 1 shows a block diagram of a mobile phone capable of presenting a clock thereon in a power-off mode; and

FIG. 2 shows a perspective view of the mobile phone capable of presenting a clock thereon in a power-off mode according to an embodiment of the present invention.

### DETAILED DESCRIPTION OF THE INVENTION

In this invention, a mobile phone capable of presenting a clock thereon in a power-off mode combines the mobile phone and the clock together so as to have the clock and an alarm clock functions concurrently even in the power off mode.

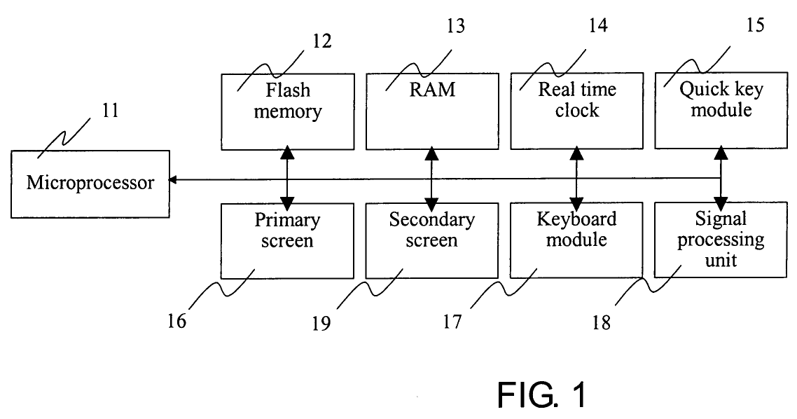

Referring to FIG. 1, a block diagram of the mobile phone capable o presenting a clock thereon in a power-off mode according according to the present invention is shown therein. The mobile phone comprises a microprocessor 11, a flash memory 12, a random access memory (RAM) 13, a real time clock 14, a quick key module 15, a primary display screen 16, a keyboard module 17, a signal processing unit 18, and a secondary display screen 19.

The microprocessor 11 is used to process various commands and information in the mobile phone.

The flash memory 12 is used to store various drive programs such as a keyboard drive program, a display drive program and a clock drive program. The keyboard drive program is used to drive a keyboard module 17 and a quick key module 15 of the mobile phone, the display drive program is used to drive the primary screen 16 and the secondary display screen 19 of the mobile phone, and the clock drive program is used to drive the real time clock 14 of the mobile phone.

The RAM 13 is a memory for both read and write. When the mobile phone enters into the clock function, the flash memory 12 loads the keyboard drive program, the display drive program and the clock drive program into the RAM 13. As such, the quick key module 15, the primary display screen 16, the real time clock 14 and some other devices in the mobile phone may be kept active.

The real time clock 14 is used to count time.

The quick key module 15 further comprises at least a quick key. When the mobile phone is in the clock mode, the user may execute functions associated with the clock, such as time displaying and alarm clock setting, by pressing corresponding quick keys.

The primary display screen 16 is a liquid crystal screen and used to display information associated with the mobile phone.

The keyboard module 17 further comprises a plurality of keys and the user may press a key to input a corresponding command to the mobile phone.

The signal processing unit 18 is used to receive a signal external to the mobile phone or transmitted a processed signal to the outside.

With the above mentioned components, the user may input associated commands to the mobile phone through the keyboard module 17 (e.g. telephone number dialing and phone book editing) and thru the primary display screen to show the information (e.g. talk time and talk object etc.). The user may also direct the signal processing unit 18 to process the received and transmitted signal so as to achieve wireless communications.

Furthermore, when the user desires to power off the mobile phone capable of presenting a clock thereon in a power-off mode, a normal power-off mode and a clock mode may be selected. When the normal power-off mode is selected, the mobile phone is powered off in a conventional manner. When the clock mode is selected, the mobile phone will follow power-off procedure to close all of functions and activate the clock mode and then entering a waiting status. At clock mode, the mobile phone still has power supplied. In addition, when the user activates the clock mode by pressing a specific key on the quick key module 15, the flash memory 12 loads the keyboard drive program, display drive program and clock drive program stored in the flash memory 12 into the RAM 13, the clock drive program being also used as an interrupt service program. At this time, although the mobile phone is in a power-off state, the quick key module 15, the primary display screen 16 and the real time clock 14 are still maintained active according to the keyboard drive program, display drive program and clock drive program loaded into the RAM 13 and the clock function is still executed.

After the user presses a specific key of the quick key module 15, the primary display screen 16 is initialized and displays the time recorded in the real time clock 14. When the user further presses a corresponding key of the quick key module 15, the other functions associated with the clock may be excited, such as alarm clock setting and time modification.

That the clock drive program is used as an interrupt service program means that the primary display screen 16 will be automatically closed in the case that no any instruction is inputted by the user after a specific period when the primary display screen 16 is initialized and then displays time.

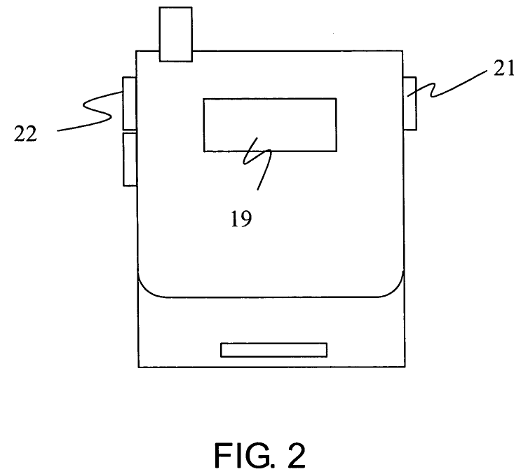

Referring to FIG. 2, a schematic diagram of the mobile phone capable of presenting a clock thereon in a power of mode according to an embodiment of the present invention is shown therein. In this embodiment, the mobile phone is a flip mobile phone having dual display screens. The operation principle of the mobile phone is identical to that described above except that an outer body of the mobile phone has a secondary display screen 19 disposed thereon and the quick key module 15 is disposed at two sides of the mobile phone.

When the mobile phone is powered off and enters into the clock mode, the flash memory 12 loads the keyboard drive program, display drive program and clock drive program stored therein into the RAM 13, the clock drive program being used as an interrupt service program when the user powers on subsequently the mobile phone. At this time, the secondary display screen 19 may be initialized to display time while the primary display screen 16 is kept in a power-off state. As such, the purposes of power saving and inconvenience elimination of outer body rotation of the mobile phone [symbol] achieved.

Further, the user may select items of clock function by pressing a quick key 22 of the quick key module 15 disposed on a left side of the mobile phone and then open or close the items of clock function by pressing a quick key 21 disposed on a right side of the mobile phone.

While this invention has thus far been described in connection with the preferred embodiments thereof, it will readily be possible for those skilled in the art to put this invention into practice in various other manners without departing from the scope set forth in the appended claims.

What is claimed is:

1. A mobile phone capable of presenting a clock thereon in a power-off mode, comprising:
a microprocessor adapted to process commands and information for said mobile phone;
a flash memory used to store drive programs for said mobile phone;
a random access memory (RAM) used to store said drive programs of said mobile phone in said power-off mode;
a real time clock configured to count time;
a secondary display screen adapted to display time; and
a quick key module further comprising at least a quick key, wherein a user press said quick key to initialize functions associated with said clock.

2. The mobile phone according to claim 1, wherein said drive programs of said mobile phone comprises a keyboard drive program, a display drive program and a clock drive program, wherein said keyboard drive program is used to drive said quick key module, said display drive program is used to drive said secondary display screen and said clock drive program is used to drive said real time clock.

3. The mobile phone according to claim 1, wherein said user further presses said quick key to set an alarm clock in said mobile phone.

4. The mobile phone according to claim 1, wherein said functions associated with said clock includes a function of initializing an alarm clock and a function of closing the alarm clock.

5. The mobile phone according to claim 1, wherein said clock drive program is an interrupt service program used to close said display screen when said mobile phone does not receive any instruction within a specific period.

6. A mobile phone capable of presenting a clock thereon in a power-off mode, comprising:
a microprocessor adapted to process commands and information for said mobile phone;
a flash memory used to store drive programs for said mobile phone;
a random access memory (RAM) used to store said drive programs of said mobile phone in said power-off mode;
a real time clock configured to count time;
a primary display screen adapted to display time; and
a quick key module further comprising at least a quick key, wherein a user press said quick key to initialize functions associated with said clock.

7. The mobile phone according to claim 6, wherein said drive programs of the mobile phone comprises a keyboard drive program, a display drive program and a clock drive program, wherein said keyboard drive program is used to drive said quick key module, said display drive program is used to drive said primary display screen and said clock drive program is used to drive said real time clock.

8. The mobile phone according to claim 6, wherein said user further presses said quick key to set an alarm clock in said mobile phone.

9. The mobile phone according to claim 6, wherein said functions associated with said clock includes a function of initializing an alarm clock and a function of closing the alarm clock.

10. The mobile phone according to claim 7, wherein said clock drive program is an interrupt service program used to close said display screen when said mobile phone does not receive any instruction within a specific period.
